(19) United States
(12) Patent Application Publication
(10) Pub. No.: US 2012/0181956 A1
(43) Pub. Date: Jul. 19, 2012

(54) Device for Storing Electrical Energy

(76) Inventor: Conrad Rossel, Syrgenstein (DE)

(21) Appl. No.: 13/387,108

(22) PCT Filed: Jul. 16, 2010
(86) PCT No.: PCT/EP2010/004350

§ 371 Date: Apr. 2, 2012

(30) Foreign Application Priority Data
Jul. 31, 2009 (DE) 10 2009 035 862.5

(51) Int. Cl. H02P 3/14; H02J 7/00

(52) U.S. Cl. 318/376; 320/134; 320/167

(57) ABSTRACT

The invention relates to a device for storing electrical energy, comprising a plurality of storage cells (12). A switch (16) and an electrical resistor (14) connected in series thereto are connected in parallel to each of the storage cells. At least one switching unit (T) closes each individual switch as soon as the storage cell located parallel to said switch exceeds a specified voltage. There is additionally a time-switch unit (T) that holds each closed switch closed for a specified time after closing has once occurred.

The invention relates to an apparatus for storing electric energy of the kind mentioned in closer detail in the preamble of claim 1. The invention further relates to a method for operating such an apparatus.

Apparatuses for storing electric energy and especially for storing electric traction energy in electric vehicles or especially in hybrid vehicles are known from the general state of the art. Typically, such apparatuses for storing electric energy are arranged by means of individual storage cells which are electrically connected in series and/or in parallel with one another. Principally, various types of rechargeable battery cells or capacitors can be used as storage cells. As a result of the comparatively high energy quantities and powers in the storage and retrieval of energy in the application in drive trains for vehicles and in this case especially for commercial vehicles, storage cells with sufficiently high energy content will be used as storage cells. They can be rechargeable battery cells in lithium-ion technology for example or especially storage cells in form of extremely powerful capacitors. These capacitors are generally also known as super-capacitors, supercaps or ultra-capacitors.

Irrespective of whether super-capacitors or rechargeable battery cells of high energy content are used, the problem arises in such configurations consisting of a plurality of storage cells which are arranged together in series in their entirety or in blocks that the voltage of the individual storage cell is limited to an upper voltage value as a result of the configuration. If said upper voltage value is exceeded during the charging of the apparatus for storing electric energy, the service life of the storage cell will generally drastically be reduced. As a result of predetermined production tolerances, the individual storage cells will typically slightly deviate from one another in their properties (e.g. self-discharge) in practice. This leads to the consequence that individual storage cells have a slightly lower voltage than other storage cells in the apparatus. Since the maximum voltage for the entire apparatus generally remains the same and represents the triggering criterion which is especially typical during charging, it will inevitably occur that other storage cells will have a slightly higher voltage and will then be charged during charging processes over the allowed voltage limit. As already mentioned, such an overvoltage will lead to a considerable reduction in the potential service life of these individual storage cells and therefore the apparatus for storing electric energy. It is a further problem that individual storage cells, as a result of a higher self-discharge, will decrease more rapidly in their voltage than other storage cells. This may lead to the consequence in the long run that the storage cells will tend to run apart increasingly in their voltage potentials. In the worst case, a reversal of polarity of the decreased storage cell will occur in the apparatus for storing electric energy, which would drastically reduce its life and needs to be prevented under all circumstances.

In order to remedy these problems, the general state of the art substantially knows two different types of cell voltage balancing which are arranged in a respectively centralized or decentralized way. In a central electronic system, all components are combined in a control unit for example, whereas in a decentralized configuration the individual components are attached to one to two storage cells on a small circuit board especially for these one to two storage cells. The generally used terminology of cell voltage balancing is slightly misleading in this case because it is not the voltages or, more precisely, the energies of the individual storage cells which are balanced amongst each other, but that merely the cells with high voltages are reduced with respect to their high voltages. Since the total voltages of the apparatus for storing electric energy remain constant, a cell which has dropped in its voltage can be increased in its voltage by the so-called cell voltage balancing over time, so that at least the likelihood of polarity reversal is reduced thereby.

A first possibility for the cell voltage balancing is the so-called passive cell voltage balancing. In this case, an electric resistor is arranged in parallel to every single storage cell. The electric resistor is chosen to be comparatively high, but still allows a multiple of the typical self-discharge current of the respective storage cell to flow. As a result, an approximately similar voltage will be obtained over time for each of the storage cells. This configuration comes with the disadvantage however that after an already short period of time there will not be any electric energy in the storage unit any more because a current which is very low but is still present will flow continuously as a result of the electric resistors parallel to every single cell and a continual discharge of the apparatus for storing electric energy will occur. The problem is further exacerbated in such a way that as a result of the current consumption in the electric resistors heat is obtained which is generally undesirable in the region of an apparatus for storing electric energy and typically needs to be cooled off. This leads to serious disadvantages in this kind of passive cell voltage balancing, which disadvantages are especially the electric losses and the undesirable development of heat.

A further approach from the general state of the art is the so-called active cell voltage balancing. In this process, an electronic threshold switch is additionally arranged in parallel to each of the storage cell and in series to the resistor. This configuration, which is also known as bypass electronics, only allows a current to flow when the cell shows an overvoltage, i.e. a voltage above a predetermined limit value for the individual cell. Once the voltage of the individual storage cell drops back into a range beneath the predetermined limit value, the switch is opened and no current will flow. As a result of the fact that a lower ohmic resistor can be used, the configuration can further lead to a quicker cell voltage balancing than the variant as described above. As a result of the fact that the electric resistor will be deactivated via the switch whenever the voltage of the individual storage cells is below the predetermined threshold, an undesirable discharge of the entire apparatus for storing electric energy can be prevented to a substantial extent. A continual development of undesirable heat is also not a problem in this solution of active cell voltage balancing.

However, the disadvantages also remains in this case that especially in the highly dynamic application of the apparatus for storing electric energy it is only one potentially occurring damage that is limited, whereas there is no long-term balancing of the individual voltage levels of the storage cells. If a renewed charging process occurs, the storage cells which were delimited in their maximum voltage via the switch just before will immediately be operated at this limit again. Especially in the case of very dynamic charging and discharging cycles, the principally damaging scenario which can be ameliorated via the resistor and the switch only very slowly will occur again within a short time sequence in precisely the same storage cells. Finally, the so-called active cell voltage balancing therefore does not truly provide a balancing of the individual voltages of the cells among one another. Instead, the storage cell will be discharged with a small bypass current on exceeding the damaging limit voltage in order to delimit the excess by slowly decreasing the overvoltage. The bypass current will only flow for such a time until the apparatus for storing electric energy is discharged again because in this case the voltage drops beneath the respective voltage limit and the switch will be opened again. The problem will arise again in the case of a renewed charging process. The previously affected storage cell will still have a much higher voltage than a cell whose voltage has been decreased for example.

It is always the target in the two illustrated possibilities that are known from the state of the art concerning the so-called cell voltage balancing that overvoltage and polarity reversal is to be prevented in individual storage cells. As explained above, this is not achieved in all cases, and especially not when a highly dynamic operation such as a very rapid succession of charging and discharging cycles as is carried out in a hybrid drive in metropolitan traffic for example occurs in the apparatus. Especially, it is possible in such applications to extend the life of the apparatus for storing electric energy by cell voltage balancing only within certain limits.

However, the life of the apparatus for storing electric energy is decisively relevant in hybrid drives, and in this case especially relevant in hybrid drives for commercial vehicles such as buses in metropolitan and regional traffic. The apparatus for storing electric energy represents a considerable part of the costs for the hybrid drive as compared to conventional drive trains in magnitudes of the required power for such applications. That is why it is especially important that in such applications it is necessary to ensure a very long life of the apparatus for storing electric energy.

WO 2006/015083 A2 describes a method and apparatus for performing cell-based balancing in a lithium battery system with several cells. A discharge time parameter will be calculated for each cell at the beginning of a charging cycle and balancing is performed for each cell which has a positive discharge time at the beginning of a charging cycle. Alternatively, the discharge time parameter will be calculated during the operation of the battery system and the balancing of the cells occurs in operation on the basis of the discharge time values.

It is now the object of the present invention to provide an apparatus and a method for operating such an apparatus which prevents the aforementioned disadvantages and ensures with minimal effort the longest possible life of the individual storage cells in such an apparatus for storing electric energy.

This object is achieved in accordance with the invention by the features mentioned in the characterizing part of claim 1. A method in accordance with the invention is provided by the features in the characterizing part of claim 6. Further advantageous embodiments of the apparatus and the method are provided in the dependent sub-claims.

It is provided in the apparatus for storing electric energy in accordance with the invention that the initially described active cell voltage balancing is extended by a time-switch unit which keeps every closed switch closed after the closing for a predetermined period of time. It is thereby ensured that every single storage cell, once it has exceeded a predetermined voltage, will be forcibly discharged for a predetermined period of time by the electric resistor when the switch is closed. The voltage present in said storage cell will therefore decrease over a prolonged period of time. This may especially lead to the consequence that during the next charging cycle for the apparatus for storing electric energy precisely this storage cell will reach the upper limit value of its voltage again and will need to be limited in its voltage by renewed closure of the switch again. Rather, a leveling of the voltage level of precisely this storage cell in comparison with the other storage cells will occur by the integration of a time function by at least one time-switch unit. Storage cells that show a decrease in the voltage will then be increased in their voltage again, so that a true cell voltage balancing will occur in the strictest sense of the word.

As a result, even in dynamic applications such as in the hybrid drive for example where a large part of the electric energy stored in the apparatus will be taken for accelerating and energy will be stored in the apparatus again during the next braking process, a renewed exceeding of the upper limit voltage of the affected storage cell will be prevented with a high amount of probability. It can thereby be prevented in a secure and reliable way with a very simple means that individual storage cells will reach the range of overvoltage several times in successive order, which would otherwise seriously impair their service life. Rather, the configuration of the apparatus in accordance with the invention leads to a rapid adjustment of the cell voltages of the individual storage cells among each other, so that even in the case of highly dynamic charging and discharging cycles far fewer storage cells will reach the problematic range of overvoltage.

The apparatus can principally be used in any storage cells which are typically arranged in series with respect to each other or in blocks in parallel and then in series with respect to each other. Rechargeable battery cells are principally possible, with the exceeding of a predetermined maximum voltage of the individual cell having serious disadvantages in the case of lithium-ion technology for example, which may optionally also lead to chemical and/or thermal damage to the storage cell right up to excess pressure in the storage cell. For security reasons this excess pressure would have to be relieved by a pressure control valve, which not only damages the storage cell in respect of its service life but also directly destroys it. The exceeding of the predetermined maximum voltage also has serious consequences in other types of storage cells, especially in super-capacitors, and will seriously reduce their service life.

It is provided in an especially appropriate and advantageous further development of the apparatus in accordance with the invention that the storage cells are arranged at least partly as super-capacitors.

This configuration of the apparatus for storing electric energy exclusively or at least partly by way of super-capacitors leads to the advantage that they can be charged with considerably higher currents at considerably lower internal resistances in comparison with any form of rechargeable battery or batteries as storage cells. As a result, the storage of very large quantities of energy which will be obtained during the braking of a commercial vehicle within a very short period of time for example is possible with comparatively low losses. Moreover, such super-capacitors are far less complex in the application and maintenance than lithium-ion batteries, because they can easily be discharged up to 0 volts and are then available voltage-free for maintenance purposes in the apparatus.

It is provided according to a highly appropriate and advantageous further development of the apparatus in accordance with the invention that the switching unit, the electric resistor, the switch and the time-switch unit are arranged for each storage cell as an independent electronic unit arranged in the region of the storage cell.

This purely decentralized configuration offers the possibility to discharge individual storage cells from a predetermined limit voltage in a purposeful manner via the resistor for a predetermined period of time. It is arranged in a comparatively simple and compact way. A respective configuration can be realized by way of an integrated circuit and a suitable resistor on a respective circuit board of small dimension for every single storage cell. It can then be arranged in the region of the individual storage cell and will operate completely independently. As a result of the fact that the response occurs in the manner as described above for each individual storage cell, the apparatus can respectively be charged or discharged in its entirety without having to take into account any damage, especially any damage of the individual storage cells by overvoltage occurring successively several times over. Since the charging and discharging process is typically always controlled on the basis of the total voltage of the apparatus, a balanced voltage level will automatically be obtained over time in the apparatus in accordance with the invention between the individual storage cells installed in the apparatus without requiring any triggering or setting of the individual storage cells from outside of the apparatus. The configuration of the apparatus in accordance with the invention can make do without any single-cell monitoring, wiring of each individual storage cell and/or a complex data bus system connected to every single one of the cells. The configuration of the apparatus in accordance with the invention is therefore respectively simple. It can further be combined with any converters and the like because no active triggering or setting of the apparatus is necessary apart from charging and discharging the same. The apparatus in accordance with the invention therefore works autonomously and can be integrated as a standardized component in various drive trains without having to be included mandatorily in their electronic control systems.

In an especially advantageous further development of the apparatus in accordance with the invention, the predetermined time can be changed depending on the voltage of the respective storage cells. This variant of the apparatus in accordance with the invention offers the possibility of allowing the bypass current to flow for differently long periods of time at each of the storage cells. The dependence can especially be set continuously or automatically on the basis of steps according to the occurring overvoltage, e.g. in the respective electronic unit. This leads to a value for the predetermined time which can automatically be changed according to its voltage for each individual storage cell. As a result, the bypass current can flow according to this predetermined time and thereby limit any exceeding of the limit voltage by a purposeful reduction in the overvoltage.

It is now provided in the method in accordance with the invention for operating such an apparatus that the energy charged into the apparatus or taken from the apparatus is controlled by a control device. This control occurs especially during charging within predetermined voltage limits, which are not voltage limits for each one of the individual storage cells, but voltage limits of the apparatus in its entirety. Moreover, the voltage of at least a few storage cells will be monitored in the apparatus. This monitoring will lead to the maximum deviation of the detected voltage values among each other. Once this maximum deviation of the detected voltage values has exceeded a predetermined limit value, the predetermined upper voltage limit will be set during charging in the next charging cycle or will even be slightly exceeded.

In the method in accordance with the invention, this intentional setting of the upper voltage limit of the apparatus will definitely lead to some storage cells exceeding the limit values because they are already at such a high voltage level if there is a respectively large deviation between the individual storage cells that the upper limit value of a number of individual cells will be exceeded during charging. In the case of this or these individual storage cells which are provided with the configuration in accordance with the invention comprising a switch, a resistor and a time-switch unit, a triggering of the switch will then occur, so that in this storage cell a discharging current will flow for a predetermined period of time via the electric resistor arranged in parallel to the storage cell. An activation of the switch and the time-switch units of the upwardly deviating storage cells can intentionally be achieved by way of the method in accordance with the invention with the knowledge that a number of the storage cells will deviate very strongly from the voltage level of other storage cells. It is not necessary in this case to provide any individual cell monitoring or any triggering of the individual storage cells, but merely the upper voltage limit is approached during charging of the entire apparatus or it is slightly exceeded. As a result of the fact that a current will flow via the resistors arranged in parallel to the critical storage cells for a certain period of time by the time-switch units, a balancing of the voltage levels of the mutually switched storage cells will occur “automatically”.

In accordance with a highly advantageous variant of the method in accordance with the invention, it is further provided that after such a charging cycle in which the predetermined upper limit value was set or slightly exceeded during charging the upper voltage limit will no longer be set for the subsequent charging cycles during the time predetermined by the time-switch unit. This means therefore that during the time in which the discharging occurs for the cells which have reached overvoltage as a result of the actuation of switches and the closure of the switches for the time predetermined by the time-switch unit the upper voltage limit will no longer be accessed for charging the entire apparatus. The voltage is therefore kept at a lower level in order to provide the individual storage cells of the apparatus with time for leveling their voltage levels without disturbing this by a renewed setting of the threshold switches. It is thereby useful to set the voltage predetermined for the entire apparatus slightly beneath the upper limit value, e.g. 80 or 90% of this limit value, for the known and therefore fixedly predetermined time in which the closed switches are kept closed. The storage cells which previously were subjected to a high voltage are therefore respectively reduced in their voltage and adjusted to the voltage level of the other storage cells. As a result, the respective storage cells will be protected in the subsequent storage cycles, having a positive effect on their service life.

It is provided in an especially advantageous embodiment of the method in accordance with the invention that the voltage of all storage cells is detected, in that the storage cells are combined into at least two blocks whose block voltages are detected and are then used as voltage values. With this configuration of at least two blocks, which depending on the number of the storage cell can typically also comprise more blocks, it can be ensured that as soon as one of the blocks shows a respective voltage difference over the other one, a leveling of the voltage values of the individual storage cells is triggered by the approaching charging cycle by way of the method as explained above. In this case, the monitoring of storage cells combined into blocks, e.g. 8 to 12 of the individual storage cells as one block, is clearly less complex than the monitoring of the voltage of individual cells. As compared to the possibility to monitor only individual storage cells as explained above in principle, the monitoring in blocks can further prevent that individual cells, since they might not be monitored, are subjected to a respective overvoltage and are damaged, which would consequently lead to damage to the entire apparatus.

It is provided in a very advantageous embodiment of the method in accordance with the invention that the apparatus for storing electric energy is used as a traction energy storage unit in a vehicle that is at least partly electrically driven. This preferred embodiment of the apparatus and the method in an electric vehicle or especially a hybrid vehicle comes with the special advantage that in such applications highly dynamic charging and discharging cycles occur, which—as already mentioned above—can lead to a considerable load on the individual storage cells in the apparatus. As a result of the configuration of the apparatus in accordance with the invention, this can be prevented, so that the aforementioned advantages will be obtained in an especially advantageous manner in the application as a traction energy storage unit in an electric vehicle or hybrid vehicle.

Further advantageous embodiments of the apparatus in accordance with the invention and/or the method in accordance with the invention are further obtained from the embodiment which will be described below in closer detail by reference to the drawings, wherein:

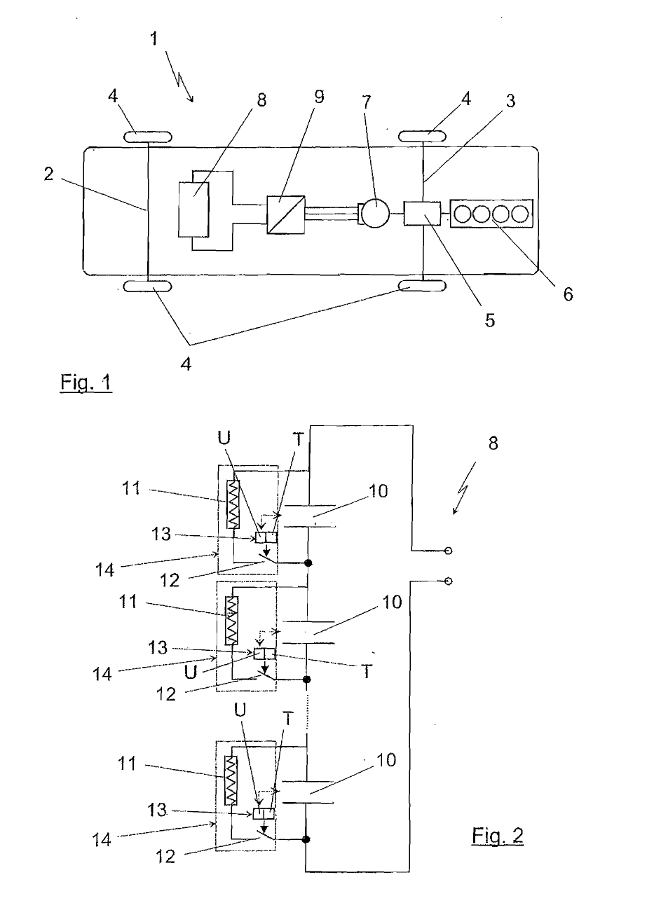

FIG. 1 shows an exemplary configuration of a hybrid vehicle, and

FIG. 2 shows a sectional view of the configuration of the apparatus for storing electric energy.

FIG. 1 shows an exemplary hybrid vehicle 1. It comprises two axles 2, 3 with two wheels 4 each respectively indicated by way of example. The axle 3 shall be a driven axle of the vehicle 1, whereas the axle 2 merely follows in the know manner. A transmission 5 is shown by way of example for driving the axle 3, which transmission receives the power of an internal combustion engine 6 and an electric machine 7 and guides the power into the region of the driven axle 3. When driving is performed, the electric machine 7 can conduct drive power into the region of the driven axle 3 either alone or in addition to the drive power of the internal combustion engine 6 and thereby drive the vehicle 1 or support the drive of the vehicle 1. Moreover, the electric machine 7 can be operated as a generator during braking of the vehicle 1 in order to thereby recuperate power obtained during braking and to store it accordingly. In order to enable providing a sufficient energy content during the use in a metropolitan bus as a vehicle 1 for braking processes from higher speeds which in a metropolitan bus will certainly not exceed approximately 70 kph, an apparatus 8 for storing electric energy needs to be provided in this case which has an energy content in the magnitude of 350 to 700 Wh. As a result, it is thereby also possible to convert energies into electric energy which are obtained for example in a braking process of a duration of approximately 10 seconds from such speed via the electric machine 7 which will typically have a magnitude of approximately 150 kW, and to store said power in the apparatus 8.

In order to set the electric machine 7 and for charging and discharging the apparatus 8 for storing electric energy, the configuration according to FIG. 1 comprises a converter 9 which is arranged in the know manner with an integrated control device for energy management. The converter 9 with the integrated control device is used to respectively coordinate the energy flow between the electric machine 7 and the apparatus 8 for storing electric energy. The control device will ensure that the power obtained during braking in the region of the electric machine 7, which is then driven in a manner of a generator, will be stored to the highest possible extent in the apparatus 8 for storing electric energy, wherein it is generally not permitted to exceed a predetermined upper voltage threshold of the apparatus 8. When driving is performed, the control device in the converter 9 coordinates the withdrawal of electric energy from the apparatus 8; in the reverse case the electric machine 7 is driven by means of this withdrawn power. In addition to the hybrid vehicle 1 which is described herein and which can be a metropolitan bus for example, a comparable configuration would obviously also be possible in a pure electric vehicle.

The apparatus 8 for storing electric energy can be arranged in numerous ways. Principally, different types of the apparatus 8 are possible for the storage of electric energy. It will typically be arranged in such a way that a plurality of storage cells 10 is typically arranged in series in the apparatus 8. These storage cells 10, which are shown in FIG. 2, can be rechargeable battery cells and/or super-capacitors, or any desired combination thereof. For the embodiment as shown here, the storage cells 10 are all arranged as super-capacitors, which are to be used in a single apparatus 8 for storing electric energy in the vehicle 1 equipped with the hybrid drive. The configuration can preferably be used in a commercial vehicle such as a bus for metropolitan or regional transport for example. In this respect, an especially high efficiency of the storage of the electric energy is achieved by the super-capacitors as a result of the frequent starting and braking maneuvers in conjunction with a very high mass of the vehicle since comparatively high currents will flow. Since super-capacitors as storage cells 10 have a much lower internal resistance than rechargeable battery cells, they are preferably used for the embodiment that is described herein in closer detail.

As already mentioned above, FIG. 2 shows the storage cells 10. Only three of the storage cells 10 which are arranged in series are shown. In the case of the embodiment as mentioned above and a respective electric drive power of approximately 100 to 200 kW, e.g. 120 kW, this would amount to approximately 150 to 250 storage cells 10 in a realistic configuration. If they are arranged as super-capacitors with a current upper voltage threshold of approximately 2.7 V per super-capacitor and a capacitance of 3000 F, a realistic application would be provided for the hybrid drive of a metropolitan bus.

It is problematic in the use of such storage cells 10 in the apparatus 8 for storing electric energy that—as already mentioned above—individual storage cells 10 can deviate especially as a result of production tolerances in their voltage level from a mean voltage level of the apparatus 8 and from the voltage of other storage cells 10. It may now occur that the limit voltage predetermined for the respective type of storage cell 10 is exceeded despite the charging voltage predetermined for the apparatus 8 in its entirety in the region of this storage cell 10 which deviates in its voltage upwardly from the other storage cells 10. It is especially disadvantageous if individual storage cells 10 exceed a maximally predetermined voltage comparatively frequently, which in the aforementioned example is the 2.7 V for each super-capacitor. Every exceeding of this limit voltage considerably reduces the achievable service life of the individual storage cells 10. A reduced service life of the individual storage cells 10 leads after a certain operating period to a failure of the respective storage cell 10, which will lead at least in the medium run to a failure of the entire apparatus 8 for storing electric energy. In order to achieve a very long service life especially under the highly dynamic charging and discharging cycles as occur in a metropolitan bus, efforts are therefore made to prevent that the individual storage cells 10 exceed this upper limit voltage frequently or at least frequently on a successive basis.

As is shown in FIG. 2, every single one of the storage cells 10 comprises an electric ohmic resistor 11 which is arranged in parallel to the respective storage cell 10. It is arranged in series with a switch 12 parallel each of the storage cells 10, in this case parallel to each of the super-capacitors 10. The switch 12 is arranged as a threshold switch and is triggered via a respective switching unit 13, which substantially contains two functionalities. Accordingly, the switching unit 13 comprises a voltage monitoring U of the super-capacitor 10. Once it exceeds an upper limit voltage, the switch 12 is closed, so that a current is capable of flowing from the super-capacitor 10 via the resistor 11. As a result, the charge contained therein and therefore also the voltage is reduced accordingly, so that a renewed exceeding of the limit voltage value is prevented in the same super-capacitor 10 as above.

A time-switch unit T is provided in order to prevent that once a voltage drops beneath the limit voltage value, the switch 12 is opened again and a very high voltage therefore remains in the respective super-capacitor 10. In the case of pure switching via the detection of the voltage U of the switching unit 13, the switch 12 would be opened again after falling beneath the limit voltage. The super-capacitor 10 would then still be at a very high voltage level. If a renewed charging of the apparatus 8 were to occur, precisely this super-capacitor 10 would immediately be charged beyond the voltage limit again, which would then lead to a renewed closure of the switch 12. As a result of the integration of the time-switch function T, which keeps the switch 12 closed for a predetermined period of time once it has been closed via the voltage detection U, a larger amount of charge is removed from the super-capacitor 10 than without the time-switch unit T. As a result, the voltage in the super-capacitor 10 is reduced to such an extent that after discharging as a result of starting of the vehicle 1 and a subsequent renewed charging of the apparatus 8 during braking, the voltage will not reach the range beyond the upper limit value. It may occur that other super-capacitors 10 lie in a respectively high voltage range and will be subjected to the procedure as described above. In summary, there will be a rapid balancing of the voltages of the individual super-capacitors 10 of the apparatus 8 as a result of the integration of the time-switch function T over the operating time.

The time-switch unit T can especially be arranged in such a way that a fixed time of a few minutes for example is predetermined. Together with the magnitude of the respective individual storage cell 10 and the value of the electric resistor 11, a respective discharge is obtained. Discharges in the magnitude of 3 to 5% of the nominal charge of the respective super-capacitor 10 are useful. It is then ensured during subsequent charging that said super-capacitor 10 will not exceed the predetermined limit voltage again. Since it is at least prevented that one of the super-capacitors 10 will exceed the limit voltage several times in rapid succession, a considerable increase in the service life of the super-capacitors 10 and therefore the apparatus 8 is achieved. When referring again to the numeric example as mentioned above, the voltage of the respective super-capacitor would decrease in 5 min by approximately 0.1 V at a discharge current of 1 A. At a discharge current of 250 mA this would occur accordingly in approximately 20 min. Depending on the size of the storage cell 10 and the potential discharge current which can be conducted via the resistor 11, a timeframe of approximately 5 to 20 min is obtained over which the time-switch unit T of the switch 12 will be kept in the closed state. It is understood that this value obviously needs to be adjusted in an analogous manner in other magnitudes of the resistors, the current and the employed storage cells 10.

The apparatus 8 for storing electric energy which is arranged in this manner can also be used in highly dynamic charging and discharging cycles without reducing the service life of the storage cells 10 by unnecessarily high voltages in the region of the storage elements 10.

The configuration of the switching unit 13, the electric resistor 11, the switch 12 and the time-switch unit T can be realized as an integrated electronic unit 14 in such a way that it is separately arranged for every single one of the storage cells 10. A small integrated circuit will generally be sufficient which respectively monitors the voltage U in the storage cell 10 and respectively actuates the switch 12 which is arranged in an integral manner in the component as an electronic switch 12 for example. The resistor 11 can then be placed on said miniature circuit board in the known manner. Since the time-switch unit T will typically always keep the switch 12 closed for a predetermined period of time once it was activated as a result of the voltage U, this time can also be fixedly co-integrated in the time-switch unit T or the integrated electronic unit 14. This can be provided for example by programming a fixedly predetermined time in an integrated circuit. It would also be possible to achieve this by way of circuit configuration in such a way that this time is fixedly predetermined at an output of the switching unit 13 in the electronic unit 14 via a suitable component such as a capacitor in particular. The configuration can therefore be realized in a very simple way because no triggering of the electronic unit 14 is required from the outside of the apparatus 8. This configuration with decentralized electronic units 14 is very simple and can be realized in an entirely autonomous way. The setting of the apparatus 8 is then merely necessary in its entirety, e.g. during discharging and especially during charging within a predetermined voltage window.

It can be provided in an especially advantageous variant however that the voltage is detected of a number of storage cells 10, especially of several storage cells 10, which are respectively arranged into blocks. This voltage value from the interior of the apparatus 8 can then be made available for example to the control device in the converter 9. The voltages are compared with each other there. If it is established that a very high deviation of the voltage values of the individual storage cells or storage cell blocks occurs, it can be assumed that a number of the storage cells 10 or blocks of storage cells 10 will soon exceed the limit voltage. This can actively be triggered in that during the next charging cycle the apparatus 8 is charged with a voltage via the control device in the converter 9 which lies at the upper threshold or slightly above the upper voltage typically predetermined for charging. As a result, a minimum exceeding of the limit voltage can intentionally be set in the storage cells 10 which deviate upwardly in a very strong way. As a result of the integrated electronic unit 14 with the time-switch unit T, said slight exceeding of the limit voltage can trigger a balancing of the voltages within the apparatus 8 between the individual storage cells 10 from outside of the apparatus 8 without requiring any purposeful setting of individual cells or blocks of individual cells within the apparatus 8.

This applies to rechargeable battery cells, especially rechargeable battery cells in lithium-ion technology.

The embodiment that has been described in a comparatively generalized manner on the basis of the super-capacitors 10 in the apparatus 8 will be specified below in closer detail by reference to a numeric example, with notice being taken that the values apply very specifically to the numeric example as illustrated herein and such values need to be adjusted in an analogous manner in the case of different capacitances of future developments concerning the maximum voltages of super-capacitors.

1.-14. (canceled)

15. A method for operating an apparatus for storing electric energy, comprising
a plurality of storage cells;
one respective electric resistor in parallel to each of the storage cells;
one respective switch in series to the electric resistor and in parallel to the storage cell, and
at least one switching unit which closes the switch once the storage cell disposed parallel to said switch exceeds a predetermined voltage;
wherein
at least one time-switch unit is provided which after the closing keeps every closed switch closed for a predetermined period of time, characterized in that
the energy charged to the apparatus and taken from the apparatus is controlled by a control device, wherein
the control device, in particular during charging, charges or discharges the apparatus within predetermined voltage limits, wherein
the voltage of a least some storage cells is detected, wherefrom a maximum deviation of the detected voltage values among each other is detected, whereupon
in the next charging cycle the predetermined upper voltage limit is set during charging or during slightly exceeding if the maximum deviation exceeds a predetermined limit.

16. The method of claim 15, characterized in that in charging cycles following such a charging cycle in which the predetermined upper voltage limit is set during charging or during slightly exceeding the upper voltage limit is no longer set during the time predetermined by the time-switch unit.

17. The method of claim 15, characterized in that the voltage of all storage cells is detected by combining the storage cells to at least two blocks, the block voltages of which are detected and are used as voltage values.

18. The method of claim 16, characterized in that the voltage of all storage cells is detected by combining the storage cells to at least two blocks, the block voltages of which are detected and are used as voltage values.

19. The method of claim 15, characterized in that the apparatus for storing electric energy is used as a traction energy storage unit in a vehicle that is driven at least partially electrically.

20. The method of claim 16, characterized in that the apparatus for storing electric energy is used as a traction energy storage unit in a vehicle that is driven at least partially electrically.

21. The method of claim 17, characterized in that the apparatus for storing electric energy is used as a traction energy storage unit in a vehicle that is driven at least partially electrically.

22. The method of claim 18, characterized in that the apparatus for storing electric energy is used as a traction energy storage unit in a vehicle that is driven at least partially electrically.

23. The method of claim 15, characterized in that a converter or a control unit integrated in a converter is used as a control device.

24. The method of claim 16, characterized in that a converter or a control unit integrated in a converter is used as a control device.

25. The method of claim 17, characterized in that a converter or a control unit integrated in a converter is used as a control device.

26. The method of claim 18, characterized in that a converter or a control unit integrated in a converter is used as a control device.

27. The method of claim 19, characterized in that a converter or a control unit integrated in a converter is used as a control device.

28. The method of claim 20, characterized in that a converter or a control unit integrated in a converter is used as a control device.

29. The method of claim 21, characterized in that a converter or a control unit integrated in a converter is used as a control device.

30. The method of claim 22, characterized in that a converter or a control unit integrated in a converter is used as a control device.

31. The method of claim 19, characterized in that the charging occurs by recuperation of braking power via a driving motor used as a generator.

32. The method of claim 20, characterized in that the charging occurs by recuperation of braking power via a driving motor used as a generator.

33. The method of claim 21, characterized in that the charging occurs by recuperation of braking power via a driving motor used as a generator.

34. The method of claim 15, characterized in that a commercial vehicle, especially a bus in metropolitan or regional traffic, is used as a vehicle.
